(19) United States
(12) Patent Application Publication
(10) Pub. No.: US 2017/0329732 A1
(43) Pub. Date: Nov. 16, 2017

(54) METHOD FOR TEMPORALLY SYNCHRONIZING THE OUTPUT AND/OR TEMPORALLY SYNCHRONIZING THE PROCESSING OF SIGNALS

(71) Applicant: dSPACE digital signal processing and control engineering GmbH, Paderborn (DE)

(72) Inventors: Heiko Kalte, Paderborn (DE); Dominik Lubeley, Verl (DE)

(21) Appl. No.: 15/586,798

(22) Filed: May 4, 2017

(30) Foreign Application Priority Data
May 10, 2016 (EP) 16168898.1

(51) Int. Cl. G06F 13/362; G06F 13/40

(52) U.S. Cl. CPC G06F 13/3625; G06F 13/4068

(57) ABSTRACT

Method for temporally synchronizing the output of signals and/or temporally synchronizing the processing of captured signals on a plurality of input and/or output channels of an electronic circuit, comprising the following steps: (a) combining a number of channels, in particular a proportion of all channels of the circuit, to form a logical group; (b) retrieving the channel latency of each channel belonging to the group from a data source; (c) determining the greatest channel latency from all retrieved channel latencies and at least temporarily storing the greatest channel latency as the group latency; (d) for each channel belonging to the group: determining the temporal difference between the group latency and the retrieved channel latency of the respective channel and storing the determined difference as a channel-associated latency offset in a memory, in particular a memory of the circuit; and (e) influencing the signal propagation via a respective channel on the basis of at least its respective stored latency offset.

### CROSS REFERENCE TO RELATED APPLICATIONS

This application claims the benefit of European patent application no. EP16168898.1, filed on May 10, 2016. The entire contents of which are hereby incorporated by reference in its entirety.

### FIELD OF THE INVENTION

The present disclosure relates to a method for temporally synchronizing the output of signals and/or temporally synchronizing the processing of captured signals, preferably synchronously captured signals on a plurality of input and/or output channels of an electronic circuit.

### BACKGROUND OF THE INVENTION

A “signal” in the sense of the present disclosure is understood here as meaning an electrical signal or other data carrier representative (bit, byte, word etc.) of an item of information. In TTL technology for example, an electrical voltage value of greater than 2.4 V can represent a logical “high” value as digital information. The term “data” also used below is therefore also understood as meaning a particular type of signal.

Electronic circuits having input and/or output channels are generally known in the prior art. They are used to output electrical signals at the pins of the output channels and/or to capture electrical signals applied to the pins of the input channels, for example by means of analog/digital conversion, in order to supply the captured signals to further processing, for example in said circuit or in further electronics connected to the circuit.

In this case, a “channel” is generally understood as meaning, for example, an arrangement of electronic circuits between an input side and an output side which perform a function associated with the channel, for example the analog/digital conversion already mentioned or analog amplification or filtering.

At least one side of the input and output sides may be provided by a pin to which an electrical signal (analog or digital) is physically applied. Depending on the channel function, the other side may likewise be provided by a pin, for example in the case of an analog amplifier, or else by a memory or a register, for example in the case of a converter which provides digital values on the output side or requires digital values on the input side.

A typical and preferred field of application, to which the present disclosure could be applied is HIL simulation, so-called hardware-in-the-loop simulation. In this case, control devices, for example motor vehicle control devices, are subjected to a test system for correct function, for which purpose the control device to be tested is connected to a circuit of the type mentioned at the outset, which is often also referred to as an I/O board, in order to impress signals on the control device and/or capture signals from the latter via the circuit.

For this purpose, the software model of a test environment, for example simulation of a journey in the case of a motor vehicle, runs in a simulation environment. Simulated events are applied to the output channels, for example the pins or registers of the output channels of the circuit, by means of electrical signals representing the events in order to thus be transmitted to the control device, and/or signals are applied to the input channels, for example the pins or registers of the input channels of the circuit, by the control device in order to thus be able to be captured and processed in the simulation environment. A control device can therefore be operated in a simulated environment as if it were actually operated in the real environment.

The simulation environment or the simulator for short is formed, for example, by a data processing system having at least one processor or a plurality of processors which are operated in a parallel manner and which execute the software model. Such a model is formed, for example, via software which typically has real-time capability, typically has a graphical user interface, for example, and often is programmed by means of software objects.

Such software is, for example, MATLAB, Simulink or else RTI (Real-Time Interface) from the applicant which forms a connecting link to Simulink, for example. In the above-mentioned cases, software objects are graphically programmed as a block, for example, in particular hierarchically. However, a simulation environment is not restricted to the use of this software which is mentioned by way of example in each case. The software model can run in the simulation environment either directly after programming or after compiling.

A processor circuit which comprises the at least one processor can be connected to at least one circuit which has the input/output channels mentioned above.

Provision may also be made for at least one such circuit, which comprises input and/or output channels, to be connected to a field-programmable gate array (“FPGA”) circuit in order to receive signals from the latter or to make signals available to the latter. An FPGA circuit can in turn be connected to the processor circuit, that is to say may be part of the simulation environment. It is therefore possible to relieve the load on the processor via an FPGA circuit since the latter can undertake, for example, subtasks which otherwise would have to be directly executed by a processor of the processor circuit.

The respective above-mentioned “connection” can be effected by means of a direct connection or else via interfaces, in particular standard interfaces, a bus or a network connection.

In the above-mentioned preferred application, but also generally in other possible applications, the requirement may arise for a plurality of electrical signals to have to be simultaneously output via a plurality of channels of the circuit and/or for a plurality of signals to have to be simultaneously processed further after being captured via a plurality of channels.

This is problematic since the signal propagation times, the so-called latencies, over different channels are different, even with channels of the same type and function, because even functionally identical electrical circuits do not have identical latencies, for example on account of series variation during production.

### SUMMARY OF THE INVENTION

It is therefore a considerable technical problem to simultaneously provide signals, preferably electrical signals, at the pins (the physical connection points of the channels) or registers/memories of a plurality of output channels after passing through the channel function, for example digital/analog conversion, even if original signals were simultaneously applied to the input side of the channels before passing through the channel function, and to capture the signals which preferably are applied to the pins/registers of a plurality of input channels in a synchronous manner and to provide the signals resulting from the result of the channel function in a synchronous manner, that is to say simultaneously, for further processing after passing through the channel function, for example analog/digital conversion, since the respective channel results are present at different times.

When carrying out synchronous input/output or further processing, users are currently dependent on a manual procedure. In order to determine the latencies caused by the channels of a circuit mentioned at the outset and of an upstream or downstream circuit, for example an FPGA circuit or a processor circuit, the simulator, that is to say the input/output circuit mentioned and upstream or downstream circuits, must be experimentally measured for each channel for each input/output circuit used according to the previous prior art.

Alternatively, users can use the data sheet of a circuit which indicates switching times of digital inputs/outputs or converter times of analog inputs/outputs. With knowledge of the times, the user must now trigger his I/O channels at different times for the purpose of (presumably) synchronous sampling/output since a type 1 converter has a conversion time of 500 ns, for example, but a type 2 converter has a conversion time of only 300 ns.

As soon as the simulation model is intended to be operated with a different input/output circuit having different technical data, the model has to be manually adapted again in a complicated manner in order to operate the channels in a (presumably) synchronous manner.

Furthermore, the user currently does not have any knowledge of the additional latency of the signals caused by parallel or serial buses or other interface or network connections which can be used to connect an input/output circuit, for example, to an upstream or downstream circuit (for example FPGA or processor circuit).

Jitter may even occur in the case of serial or compressed transmission. Completely synchronous output is therefore currently not possible. A user can still measure the latencies using an oscilloscope, if necessary, but cannot compensate for the jitter.

Whereas it is often also already nowadays possible to synchronously operate a plurality of inputs or outputs of one channel type (with a presumably consistent converter time), this is not readily possible across channel types.

After measuring the latencies according to the prior art and even in a solution according to the invention as described below, the data for compensating for the latency differences between the plurality of channels can be sent, with a corresponding delay, from an upstream circuit, for example an FPGA circuit or a processor circuit, to the output channels, that is to say, in particular, to the input side or an input stage (for example a register) of output channels on the input/output circuit mentioned, for the synchronous output via output channels of the circuit.

Such measurements by the simulator and the manual setting of the delays are complicated and are therefore implemented only in exceptional cases.

If jitter can additionally occur on the transmission path from an upstream circuit (for example FPGA) to the output channel of the circuit (I/O board), the signals or data represented by the latter must be buffered in the circuit and synchronous further processing in the circuit (I/O board) must be triggered after the maximum possible latency. This again delays the output of all data.

During synchronous sampling, that is to say capture of signals, the signals or data are buffered after being transmitted from the circuit (I/O board) to the downstream circuit (for example FPGA circuit or processor circuit) according to the previous prior art in order to ensure that synchronously received signals/data are processed further together in the downstream circuit (for example FPGA or processor circuit) despite different latencies and possibly jitter.

In the case of known jitter-free latencies, the latency differences can be compensated for in the downstream circuit (for example FPGA), but the latencies must be previously determined experimentally and manually for this purpose, like for output.

The process of compensating for latency differences and possibly jitter is generally associated with speed losses since an input or output channel with the greatest latency and/or the greatest possible jitter predefines the speed which can be achieved. The user must therefore decide whether he wishes to output the data as quickly as possible or in a synchronous manner later with more effort.

The previous procedure results in latencies and possibly jitter nowadays being compensated for only in exceptional cases. In a simplified manner, input/output channels of the same type are assumed to be inherently synchronous enough. The effort needed for the better synchronicity of different input/output channels is often not confronted with any corresponding benefit.

Against the background of the problems described, an object of the invention is to automatically take into account the unavoidable latencies in the channels of hardware components used, in particular in the input/output circuits which are connected to control devices to be tested in a simulation environment, that is to say, in particular, to make it unnecessary to experimentally determine the individual latencies before using the circuit. In this case, latencies are intended to be taken into account automatically and depending on which channels of all channels are intended for synchronous input or output of signals.

This object is achieved by combining a number of channels, in particular a proportion of all channels of the circuit which comprises input and/or output channels, to form a logical group, retrieving the channel latency of each channel belonging to the group from a data source, determining the greatest channel latency from all retrieved channel latencies and at least temporarily storing the greatest channel latency as the group latency. Furthermore, for each channel belonging to the group, the temporal difference between the group latency and the retrieved channel latency of the respective channel is determined and the determined difference is stored as a channel-associated latency offset in a memory, in particular a memory of the circuit. According to the invention, the signal propagation via a respective channel is then influenced on the basis of at least its respective stored latency offset.

### BRIEF DESCRIPTION OF THE DRAWINGS

FIG. 1 depicts an exemplary output channel block and an exemplary input channel block.

FIG. 2 depicts exemplary assignment of I/O groups by using I/O channels in group objects.

FIG. 3 depicts output group latency and input group latency of I/O groups.

FIG. 4 depicts output channel group with negative offset and input channel group with positive offset.

FIG. 5 depicts a timing diagram for a channel in an I/O output channel group and an I/O input channel group.

FIG. 6 depicts latencies of output and input channels.

FIG. 7 depicts mixed input/output group latency of I/O groups.

### DETAILED DESCRIPTION OF THE INVENTION

The present disclosure shows that it is necessary to determine only those channels which are intended to be synchronized, which can be carried out, for example, by the user in the software model of the simulation environment, for example in a user interface, preferably a graphical user interface, by combining the channels there to form a group.

The simulation environment itself then carries out the synchronization by automatically taking into account the individual latencies of the respective channels which have been combined to form the group. For this purpose, the present disclosure provides for the latencies of each channel of a circuit to be available in a data source for retrieval and use.

Therefore, there is no longer any need for users of a simulation environment to measure the latencies themselves or to manually acquire them from data sheets and take them into account during programming. The content of the data source, that is to say the latencies stored therein for each channel, preferably can be provided by the manufacturer of a circuit, particularly preferably individually for each circuit, that is to say even for different circuits which are technically structurally identical. For this purpose, the latencies of the channels associated with a circuit or data representing them can be determined using a circuit identifier, for example the individual serial number from the data source, in particular provided that the data source overall has not already been assigned to the circuit in an individualized manner.

The present disclosure therefore makes it possible for the latencies of the individual channels to already be disclosed to the modeling or configuration tool of the simulation environment, for example its graphical user interface, directly by the manufacturer, for example. If a user therefore desires synchronous output or sampling of the signals/data from a plurality of channels, a corresponding delay of the signals/data for compensating for the latencies is automatically modeled by the tool. In this case, such a delay is oriented to the maximum latency from the latencies of all channels which defines the group latency and is automatically determined according to the invention.

The present disclosure preferably can provide for at least one respective value for the respective channel latency and the group latency to be depicted in a channel object which is used, in particular, during programming, preferably object-oriented graphical block programming, preferably inside a graphical user interface. The user can immediately use and take into account the information obtained in this manner during his programming. For example, the user can therefore easily decide the channels for which he would like synchronous output or input/sampling and can identify what additional delays this signifies for the individual channels.

The present disclosure preferably provides for a respective channel to be assigned to a group by storing a group identification in a channel object of a user interface, which channel object is assigned to the respective channel. In a preferred embodiment, a group identification may be a group number, for example. Different channel objects which are used during programming are therefore given a logical link to one another which can be directly taken into account by the software model of the simulation environment. In the present disclosure, a graphical user interface (GUI) can generally be used as the user interface.

A channel can also be assigned to a group by generating a group object and storing a channel object of the respective channel in the group object of the graphical user interface. This preferably can also produce a hierarchical arrangement inside one another, which immediately also demonstrates the group assignment to the user, in particular in the graphical user interface, in a form which is visually easy to understand, and internally defines the assignment for the software model via the common group object.

One development may also provide for an activity signal to be generated on the basis of a group latency, which activity signal indicates or signals the time at which the channels in the group have an active signal at their respective channel connections/pins or the memory/register assigned to a channel. In this case, the activity signal preferably can be assigned to the channel object and/or group object, for example as an object to which further links are possible, in particular.

Such an assignment may provide for the activity signal to be available in the form of a parameter whose value can be changed or a variable inside the channel or group object; links to other objects can therefore also be established using said activity signal, in particular. Such a value may assume a logical “1” or “0”, for example, in which case the “1” can indicate the activity. Such an activity signal may therefore also be used, for example, to trigger other program parts, for example subroutines or objects, which has the advantage that execution can start precisely when the signal is present.

In the case of output channels, the signal can therefore indicate when the respective output signals are present on all channels, or at their output connections, in particular pins or registers, in the group. In the case of input channels, the signal can indicate when, on all channels, the signals present on the input side are present on the channel output side, for example in a memory/register or likewise a pin, that is to say can be supplied to synchronous further processing, after passing through the channel function. In addition, the sampling time of the signals at the pin before passing through the channel function can be indicated by means of a further activity signal. This signal makes it possible to determine in an improved manner the time at which a measurement was carried out.

In the case of output channels in particular, such an activity signal can therefore also indicate when previous values stored for each output channel in the group have been overwritten with new values, with the result that, when taking this signal into account for the purpose of triggering further program parts, it can be ensured that the execution takes place with the new current values.

Provision may also be made for different activity signals to be provided for output channels and input channels, in particular if output and input channels are represented in mixed form in a group in one possible configuration of the present disclosure.

The present disclosure may also provide for a channel offset to be stored in the channel object for at least one of the channels in the group, which channel offset is used to define an intended deviation of the signal propagation via the channel from the group latency. The user can therefore use such a channel offset to deliberately achieve a deviation for this at least one channel from the synchronicity which is otherwise present. Such a channel offset can therefore represent a variable in the channel object, to which the user can individually assign a desired value. The channel offset may have positive or negative time values, that is to say, in particular, may shift a signal on such a channel in both possible directions relative to the group latency.

When carrying out the method, provision may be made for at least the above-mentioned steps according to the invention of defining the group, retrieving the channel latency, determining the greatest channel latency and storing the channel-associated latency offset to be carried out using the graphical user interface which is implemented by means of software on a data processing system which is connected to the circuit comprising the input and/or output channels by at least one communication connection, preferably in a bidirectional manner.

This communication connection may be formed inside the simulator or else outside, for example via a network or interface or bus connection. As a result of this configuration, the latency values of the channels become directly accessible when programming the simulation environment or the simulator.

The step of influencing the signal propagation via the respective channel in a formed group preferably can be carried out by software or hardware-implemented logic of a circuit, to which the latency offsets of all channels in the group have been transmitted by means of previous communication.

The software can be formed by the simulation model which preferably calculates the simulation in real time and generates signals, for example those for a control device, or receives signals, for example from a control device, with the interposition of said input/output circuit in each case.

Hardware-implemented logic can be directly formed on said input/output circuit or else on a separate circuit, for example a separate FPGA circuit in the simulator, which is communicatively connected to said input/output circuit, in particular via the above-mentioned network, interface or bus connection.

Both the software and the hardware-implemented logic can delay the control of the channels on the basis of the respective channel latencies in the case of outputs, for example, the delay being oriented to the latency offset mentioned at the outset. For this purpose, the signals to be output can be transmitted to the input sides, for example input stages of the output channels of the circuit, with respective delays dependent on the latency offsets, for example.

In this case, provision may also be made for the signals to be output to all be transmitted to an intermediate register of the circuit in which they remain buffered until the expiry of a delay time which takes into account maximum possible jitter, for example on the connection path. It is therefore ensured that, even under the effect of jitter, all signals have reached the intermediate register before the actual output via the channels is started. After this output has been started, the output channels are then each triggered on the basis of the latency offsets of each channel, for example where channel-assigned data such as latency offsets are stored on the data processing system.

In this case, provision may be made for all signals/data for all grouped channels to be shifted to a buffer and for programmable logic, for example an FPGA, to shift signals intended for a respective channel or the intended data to the respective channel after triggering. In this case, the programmable logic can heed the channel latencies and desired offsets. As a result, although the channels all operate in a parallel manner in terms of the channel function in particular, the buffer may be serially connected to the circuit.

In contrast, in the case of inputs, the respective signals, in particular the signals handled by the channel functions, can be jointly retrieved by the software or logic after expiry of a buffering time, for example in a register, the buffering time taking into account the value of the group latency, in particular corresponding at least to the group latency.

The latency differences, in particular caused by channel-specific delay in the case of outputs or channel-specific buffering times in the case of inputs, can also be compensated for directly on the input/output circuit (I/O board) in one configuration, in particular when hardware-implemented, preferably programmable logic (for example in the form of an FPGA) or software executed by a local processor is directly present there and influences the signal propagation between the channel input side and the channel output side.

In this case in particular, the determined latency offsets can also be stored in a memory directly on said circuit. In this case, the present disclosure may provide for the programmable logic on the circuit or for the local software for influencing the signal propagation to be programmed directly on the basis of the latency offsets for each channel or at least for each channel assigned to a group on the circuit in order to synchronize its signal propagation with the other channels in the group which has been formed.

This embodiment is particularly advantageous if the input/output circuit is not directly arranged in the simulator on the processor circuit or on programmable or programmed logic (FPGA circuit), but rather the connection is effected via at least one communication path such as a network, bus or interface connection.

The practice of buffering signals from a plurality of channels before further processing (output or input) also additionally makes it possible to compensate for jitter between an upstream or downstream circuit (for example FPGA circuit) and the input/output circuit (I/O board). For such jitter compensation, the maximum possible jitter between an upstream or downstream circuit (FPGA) and the input/output circuit is preferably known to the simulation environment.

In particular, if an upstream or downstream circuit is in the form of programmable logic (FPGA) which transmits signals to the input/output circuit for synchronous output or synchronously receives a plurality of signals from the input/output circuit, the present disclosure may provide for the method steps according to the invention to be executed at least partially, possibly completely, by the programmable logic, for which purpose the method steps can be implemented in an FPGA programming environment, preferably likewise in a block-based and/or object-based manner.

In one possible embodiment, the data source mentioned at the outset for retrieving the channel latencies stored therein may be formed by a set of data which are assigned to each channel and are stored, in particular as a file, on the data processing system, that is to say preferably the simulation environment, on which the graphical user interface is executed, and are read into the software for generating the user interface.

The channel-assigned data may be in the form of a library, for example, on the data processing system and may be read therefrom on the basis of the input/output circuit used, for example on the basis of an identifier of the circuit.

Provision may also be made for the data source to be formed by a set of channel-assigned data which are stored in a memory element, in particular a memory element common to all channels, on the circuit, from which the data are read and are transmitted, by means of communication, to the software for generating the user interface.

Each circuit can therefore always carry the latency values relating to it, in particular if the manufacturer of the circuit has stored the channel latencies in the local memory of the circuit for retrieval after measuring the circuit.

One embodiment may provide for the data source to be formed by a set of channel-assigned data which is loaded, via a communication network, from a server, in particular a server of the circuit manufacturer, onto the data processing system on which the graphical user interface is executed, and which are read into the software for generating the user interface, or else is loaded onto a memory of the circuit. The first-mentioned alternative, in particular, has the advantage that no memory area on the circuit has to be provided for holding the data. In this embodiment, the data can be loaded from the server on the basis of a circuit identifier, for example a serial number.

Provision may also be made for the data source to be formed by a set of data which are directly input into the software for generating the user interface by a user of said software.

Generally when using a respective channel function and, in particular, when carrying out a simulation for the purpose of testing a control device, the present disclosure may provide for the function of that channel in the defined group which has the greatest retrieved channel latency to be initially triggered at an initial triggering time for the purpose of initiating signal processing with this channel, in particular according to its specific functionality, and for the function of the remaining channels in the group to be gradually triggered for the purpose of initiating signal processing with the respective channel in the order of decreasing retrieved channel latencies with an interval of time from their respective stored latency offset. Such an embodiment will be effected, in particular, when outputting signals via output channels. The subsequent channels can be gradually triggered by means of a respective timer which is loaded with the relevant latency offset at the initial triggering time and starts the counting, in which case the relevant channel is triggered in a manner temporally offset by the latency offset after counting down.

In this case, the present disclosure can provide for above-mentioned respective triggering to initiate the channel function only indirectly, rather than directly. For example, the triggering can also control programmable logic which is upstream of the channel and then transfers a signal intended for the relevant channel or intended data from a buffer to the input stage of the output channel which then starts the channel function. In this case, the programmable logic can heed the channel latencies and desired offsets.

During triggering, triggering time shifts can generally be effected on the basis of positive or negative channel offsets, in particular relative to the initial triggering time. As mentioned at the outset, a user, for example, may have defined such channel offsets in a channel or group object.

The present disclosure may also provide for the functions of all channels in the group to be triggered at the same time for processing respective signals and for the signals processed by the channel function to each be buffered in a register, and for the processed signal of each channel to be supplied, from the register, to further processing in a manner delayed with the respective stored latency offset, in particular plus a positive or negative channel offset. Such further processing can also be carried out in a triggered manner, for example on the basis of the expiry of the longest delay time or the group latency and/or on the basis of an above-mentioned activity signal. Such a trigger can cause all processed signals to be synchronously retrieved from a buffer in order to carry out the further processing. Such embodiments will therefore be carried out, in particular, when capturing signals via input channels and ensure in this case that the processed signals can be synchronously supplied to further processing after being captured on the output side of all grouped channels.

The present disclosure may provide for the above-mentioned individual triggering of the different channels to be carried out taking into account the latency offsets of the channels caused by an upstream or downstream circuit such as said processor circuit or else the FPGA circuit. A plurality of trigger signals are advantageously provided in this manner when the circuit having the input/output channels is directly connected to the upstream or downstream circuit, that is to say in the same data processing system which calculates the simulation, for example.

The present disclosure may also provide for a group triggering signal to be provided, which signal defines a triggering time which is intended to synchronously initiate the channel functionalities of all channels in the group, in particular directly or else indirectly after previously initiated actions. Such a group triggering signal may be formed in the software model of the simulation and may be an object variable of a group object and/or each channel object, for example, in terms of programming.

This embodiment has advantages, in particular, when a circuit having input and/or output channels is connected to an upstream or downstream circuit by means of a communication connection, for example an interface connection, a network connection or a bus connection. In this case, only a single signal must be transmitted to the circuit having the channels for the purpose of initiating all grouped channel functions in a temporally synchronous manner.

Irrespective of the type of connection to that circuit which transmits the group trigger signal, the channel function of each channel in the group can be initiated on the circuit having the channels after the group triggering signal has been received.

For this purpose, provision may also be made for the received group triggering signal to be converted into individual trigger signals for each channel, the respective latency offset preferably stored on the circuit being included in each individual trigger signal formed, in particular in the manner described above. The conversion is carried out directly on the circuit, for example by means of logic or software programmed there on the basis of the stored latency offsets. The embodiment is particularly advantageous in the event of an existing communication connection between the circuits, in particular via a network, an interface, preferably a serial interface, or a bus.

The present disclosure may also provide for a mixture of both output channels and input channels to be present in the group, rather than logically combining only output channels or only input channels in a group. In such an embodiment, triggers for outputting signals and triggers for starting synchronous further processing of captured signals can be initiated on the basis of the group latency. These two different triggers (reading and outputting) can be initiated at the same time or with a temporal (positive or negative) offset with respect to one another. In order to take an offset into account, such an offset can be stored in a group object, in particular in a manner assigned to the output channels or input channels in the group.

With regard to the channel latency, it can generally be stated that the channel latency may be composed of a plurality of latencies. For example, the time for the signal conditioning in the channel and the time for transferring the signal via the channel can be added in order to form a value for a channel latency.

One embodiment may also provide for further latency values, for example those which result from the transmission times on a connection path between the circuit having the input and/or output channels and an upstream or downstream circuit, to be added to the latencies determined from the data source for each channel. Although such an additional latency value cannot be read from the data source, it can be experimentally determined, for example, by temporally measuring the connection, for example by “pinging” the connection path.

Additional exemplary embodiments of the invention are described below.

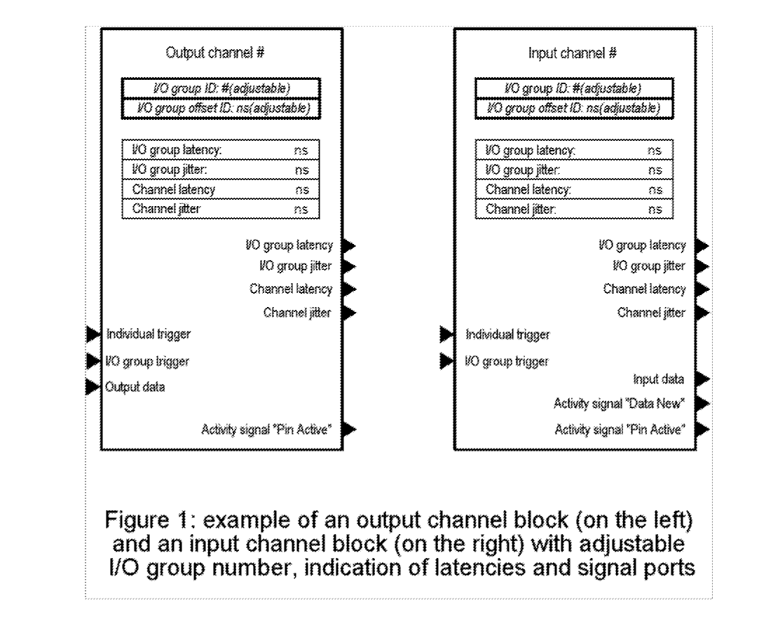

FIG. 1 depicts the combination of a plurality of channels of a circuit having input and/or output channels to form a group. The arrangement of blocks in a graphical user interface of the programming environment of a simulation environment is illustrated. The block on the left represents the object of an output channel and the block on the right represents the object of an input channel. If these channels are intended to be synchronously operated, the user can merge the channels to form a logical group. Such a group is referred to as an I/O group below. The user therefore models I/O groups and can therefore state that the output data are all intended to arrive together at the pin of the channels in a synchronous manner or that the input data are all captured together at the pin in a synchronous manner or can be processed further in a synchronous manner after they have been captured. In this case, the channels are combined to form a logical group by stating an I/O group number in the respective channel object according to FIG. 1.

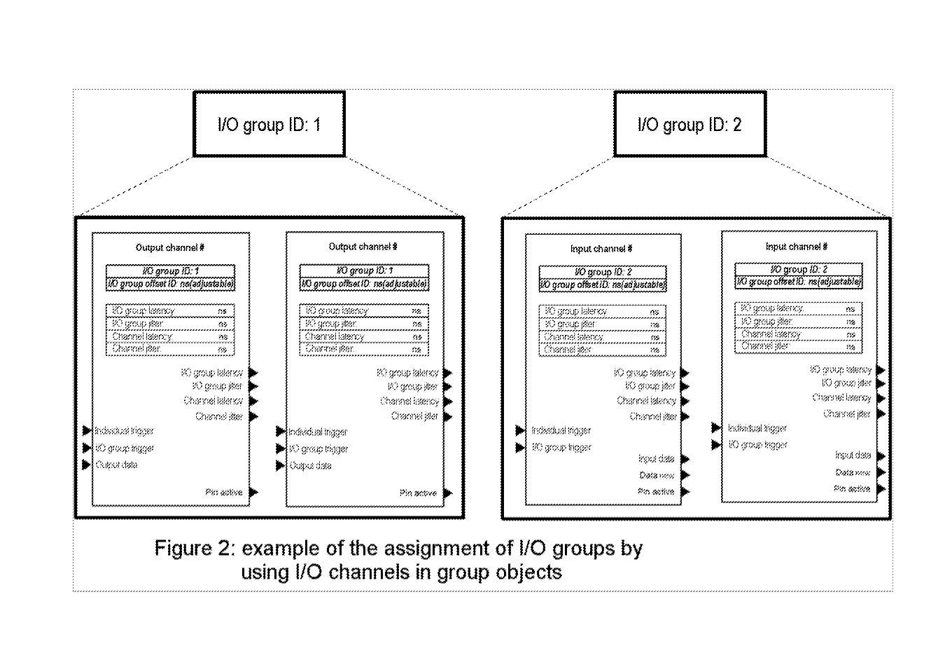

Alternatively, according to FIG. 2, the channels can be combined to form a logical group by virtue of a user arranging the channel objects of those channels which are intended to operate in a synchronous manner in a group object, as is illustrated in FIG. 2 by the frame surrounding the channel objects. This also illustrates the hierarchical programming inside the graphical user interface of the programming environment of the simulation software, for example Simulink.

On the basis of the group assignment carried out by the user, the software identifies those channels for which the channel latencies are retrieved according to the invention from a data source (not shown here). These channel latencies are depicted here in the channel object as a value and the group latency is determined for the entire group from the channel latency which has the greatest value of all channels, which group latency is likewise depicted here in the channel object. The individual latency offset is determined for each channel relative to the group latency and is stored, for example on the circuit having the channels.

The time at which the signals/data are present at the pin is referred to below as t_{IO P}_{ᵢₙ} and corresponds to the group latency provided that the group latency is considered as a delay with respect to the time t=0.

Optionally, a positive or negative temporal offset relative to the group latency can be additionally stated for each channel in an I/O group. This is referred to below as Δt_{n wOffset}(output offset) or Δt_{n rOffset}(input offset) and is relative to t_{IO P}_{ᵢₙ}. In comparison with the output time which is determined by the group latency, a shift can therefore be programmed for a channel in order to deliberately allow this channel to deviate from the synchronicity.

The practice of storing the determined latency offsets for each channel now makes it possible, according to the invention, for each channel to be individually triggered or for its signal propagation time to be delayed in such a manner that its signal is present at the outputs of the channels, for example pins, in synchronism with the signals from all other channels in the group.

The present disclosure may provide here for values of the channel and/or group latency and of the jitter of a channel or I/O group to be displayed. This display is effected in the channel object during programming on a graphical user interface. As a result, the user knows when he needs to address the group in order to be able to synchronously read the signals in/out at the I/O pin at a time determined by the user.

Latency and/or the jitter of a channel or an I/O group can also be provided as a respective signal. The user can therefore generically create his model in such a manner that it can automatically react to different latency and/or jitter values since they are available for processing in the model and on the hardware used during simulation. The change between different I/O channels/I/O boards (which actually result in different latency and jitter compensation) therefore does not require any further adaptations to the model by the user.

In the case of FPGA modeling in particular, an activity signal called “Pin active” is used to indicate to the user on the output channel block when the signals from the group are actually present at the respective pin of the output channel.

In the case of input channels in an I/O group, the acceptance of all input signals processed according to the channel function in the respective output stages of the input channels in the group is indicated to the user, for example using an activity signal referred to as “Data new”. In addition, the sampling time of the signals at the pin can be indicated by the activity signal “Pin active”.

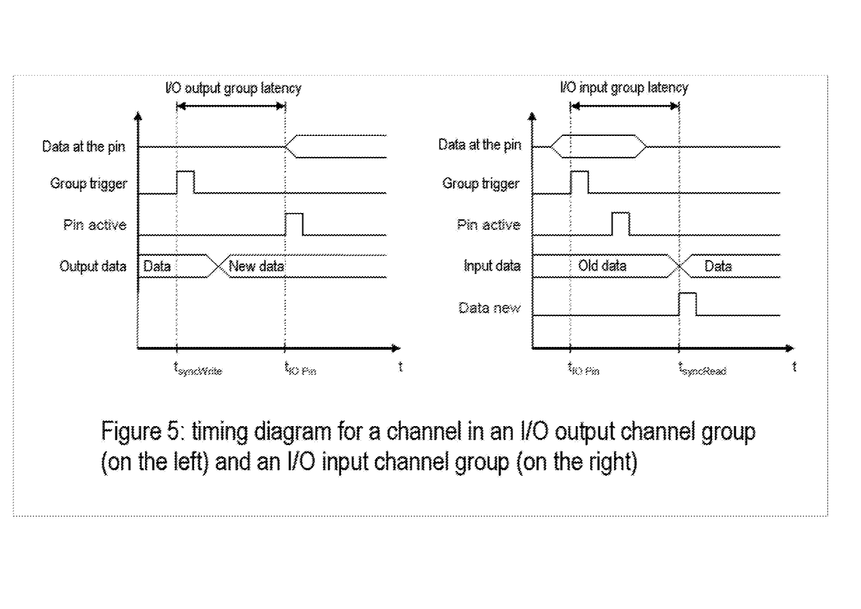

FIG. 5 illustrates the timing of the “Pin active” signal which is guided out at the channel block, as can be seen in FIG. 1 and FIG. 2.

The activity signals “Pin active” and “Data new” can be helpful during programming; for example, they can trigger further program parts (for example submodels).

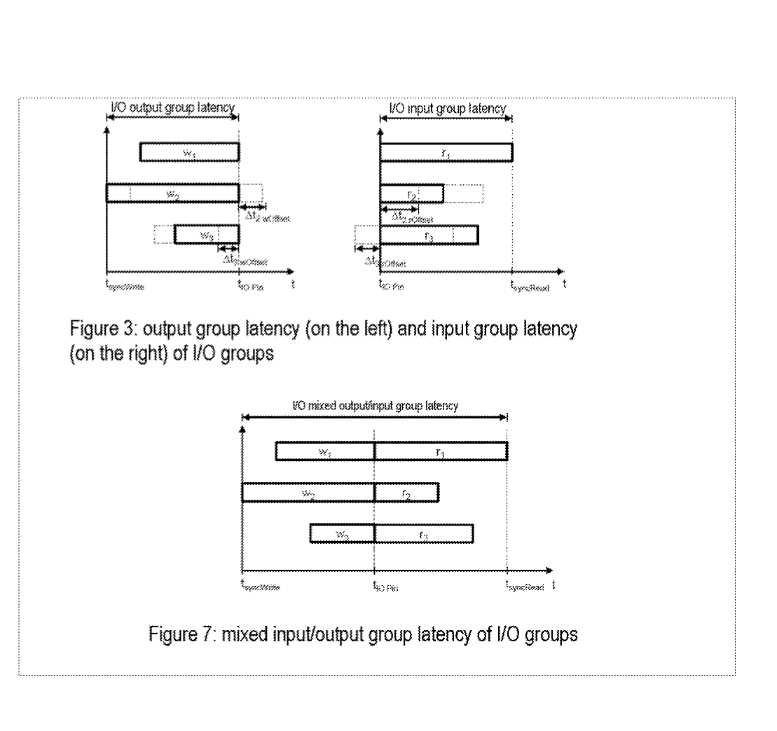

FIG. 3 depicts this for three output channels, by way of example, on the left and for three input channels, by way of example, on the right. In this case, it can be seen on the left that the channels are triggered with a different delay, the signal propagation time being symbolized by the boxes. The central channel here with the longest signal propagation time is started without a delay at the time t_{syncWrite}. The triggering of the further channels is oriented to its initial triggering time plus the respective latency offset. As can be seen, all boxes end at the same time t_{IO P}_{ᵢₙ} on the right-hand side, that is to say all channels output their signals at the same time, for example to a control device to be tested. The illustrated offsets illustrate that the user can optionally shift the channel behavior to earlier or else later times starting from t_{IO P}_{ᵢₙ} by means of an offset which can be individually additionally programmed for each channel.

It can be seen in the right-hand image that the channels provide their processed signals at the time t_{syncread} (uppermost channel) or at different times before t_{syncread} depending on the channel latency. According to the invention, the signals are accepted into the further processing only after expiry of a waiting time which is different for the channels and corresponds to said respective channel-assigned latency offset. In this case, the uppermost channel with the longest channel propagation time determines the earliest possible acceptance time t_{syncread} into the further synchronous processing.

Signals or data are synchronously read into the input stages of the respective input channels, that is to say the signals are sampled or are read from a common register or a respective register, at t_{IO P}_{ᵢₙ}. In this case, the further processing after passing through the channel function can be triggered after expiry of the group latency and therefore at the earliest at t_{syncread} if all channels have started the channel function in a triggered manner at the same time at t_{IO P}_{ᵢₙ}.

The advantage of synchronous forwarding in the case of input data in comparison with “each channel as quickly as possible” is that downstream electronics, for example a controller, always receive a new set of input data at a particular time. However, the synchronous forwarding of the input data is optional and is an advantage of the invention which does not necessarily have to be used.

However, FIG. 3 also depicts here on the right another advantage which can be exploited using the present disclosure, namely that the different converter lead times of the channels are taken into account in the channel latencies of the input channels, in particular instead of different passage times. In particular, the respective channel latency of an input channel can solely represent the individual converter lead time or can concomitantly comprise this at least as a temporal part. The present disclosure can therefore cause the conversion to be triggered at different times on the basis of the different lead times and, as a result, can cause the input signals to all be synchronously accepted into the converter stages of the grouped input channels at the time t_{IO P}_{ᵢₙ}.

As already described above, initial triggering can be effected here in the channel having the greatest channel latency (that is to say the greatest converter lead time in this case). The further channels are each triggered at an interval of time from the initial trigger corresponding to the respective latency offset. This type of triggering means that the signals can be synchronously accepted into the respective converter stages.

A special embodiment of the invention may use a deliberate deviation from this synchronicity of the signal acceptance into the converter stages by taking individual channel offsets into account. This may be used in a particularly advantageous manner to sample a single signal, preferably an analog and temporally varying signal, in a temporally highly resolved manner, for example, using a plurality of input channels, for example A/D converters, at which said signal is present in a parallel manner.

Respective channel offsets can be set here for a plurality of input channels or all input channels in a group, wherein the channel offsets are equidistant from channel to channel in particular, as a result of which the signal is successively accepted into the different converter stages of the input channels at the temporal interval of the channel offsets, that is to say the signal is therefore sampled repeatedly, in particular, with a temporal resolution of the (preferably equidistant) channel offset according to the number of channels used. Temporal resolutions which are considerably better than the resolution which would be achieved if the same input signal were triggered repeatedly in succession can therefore be achieved when capturing a signal.

The respective group latency results from the greatest latency among all channels combined to form the group.

As mentioned, a user can set a positive offset (cf., for example, Δt_{2 wOffset} or Δt_{2 rOffset} in FIG. 3) or a negative offset (cf., for example, Δt_{3 wOffset} or Δt_{3 rOffset} in FIG. 3) for each channel in an I/O group.

If an offset is provided in a channel, this always results in asynchronicity of this channel in comparison with the group latency or in comparison with the synchronicity of the remaining channels which do not have an offset provided that the value of the group latency is not corrected. This is shown on the left and on the right in the central and lower channels in each case in FIG. 3, for example.

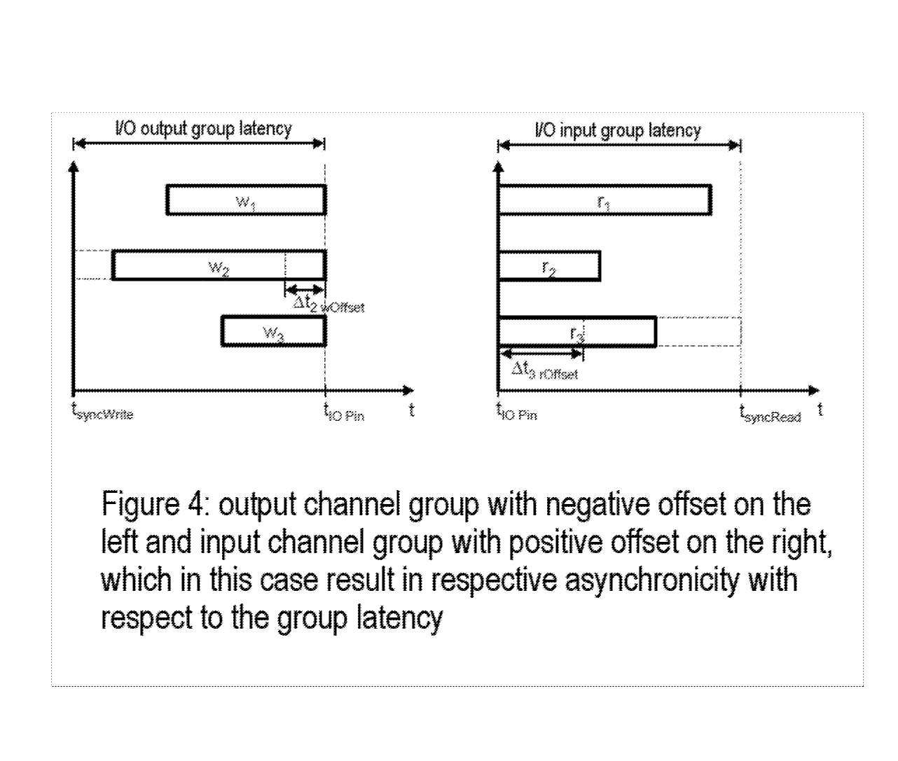

The present disclosure may provide for the value of the group latency, which is formed according to the invention in accordance with the definition mentioned at the outset, to be changed in a respective group on the basis of at least one channel offset of all channel offsets, in particular in order to achieve synchronicity of all channels in a group, despite taking individual channel offsets into account, in particular as is shown on the left using the central channel and on the right using the lower channel in FIG. 4.

In particular, the following preferably can apply to output channels:

New group latency=original group latency+maximum of respective(channel offset−latency offset) over all channels.

For output channels, it preferably can be the case that the value of the group latency, formed according to step c) of claim 1, is corrected before carrying out step d) according to: new group latency for step d) =group latency of step c) minus the channel offset of that channel in the group which has the greatest channel latency. In the case of a negative channel offset, the group latency is therefore increased, as is shown on the left in FIG. 4 in comparison with FIG. 3 which does not take the offsets into account.

FIG. 5 depicts the temporal behavior using the example of one channel and its pins in each case.

According to the invention, each channel may receive its own trigger signal which can be temporally shifted, starting from an initial trigger signal, on the basis of its latency offset. The present disclosure can also provide for a group trigger for the entire group to be generated, referred to here as group enable. For the situation on the left in FIG. 5, it becomes clear that the output signal is present at the pin of the respective channel after expiry of the group latency starting from the group trigger, which can be indicated by the additional activity signal “Pin active”.

In the case of the input on the right-hand side, it becomes clear that a signal present at the input replaces the previous value at the output of the channel after expiry of the group latency starting from the group trigger and can be read from a register by means of a trigger t_{syncread} which is dependent on the group latency. This can then be carried out at the same time for all channels since, according to the invention, all channels have concluded the signal acceptance into the intermediate register after expiry of the group latency.

The further activity signal “Data new” indicates that the new data have been accepted into said register. The preferably rising edge of this activity signal signals the earliest triggering time t_{syncread} from which the register containing the new data can be read.

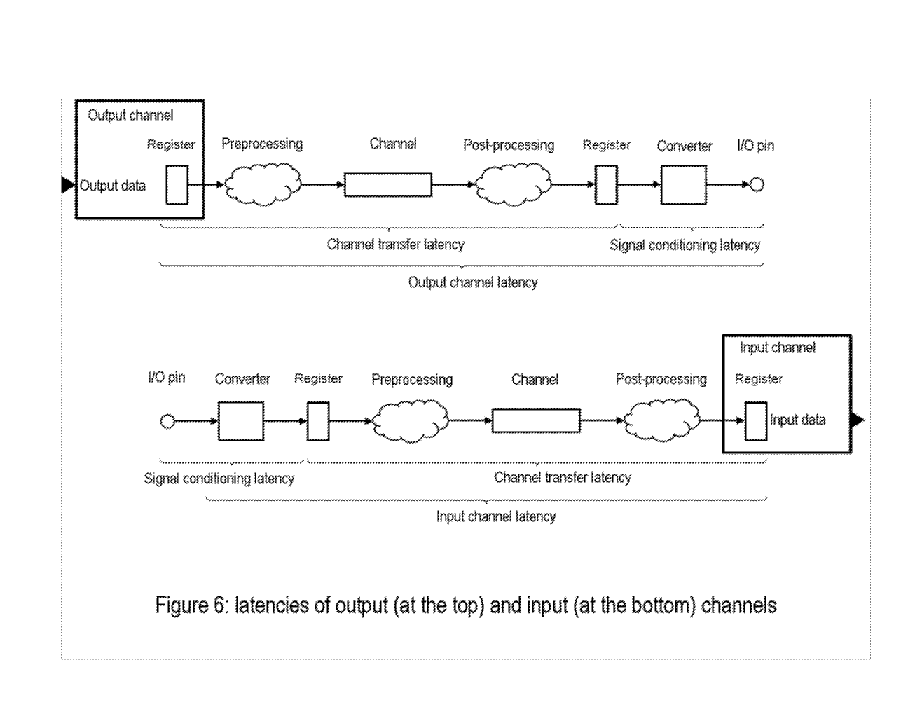

FIG. 6 illustrates the fact that a latency to be taken into account for each channel according to the invention can be composed of different latency parts. These parts result, during output via a channel (top of FIG. 6), between an input side and an output pin of the channel. In this case, the total latency is composed of a transmission latency and a signal conditioning latency. The same applies in the reverse direction to an input channel at the bottom of FIG. 6.

In this case, the figure shows that, inside a channel for separating possibly different time domains, a register stage may be situated in the channel between an input/output circuit and an upstream or downstream circuit, for example an FPGA circuit. The block “preprocessing” illustrates that further processing is often also required for transmission to the I/O channel, for example bit width matching, compression or serialization, if the I/O channel is connected via a serial bus or a digital filter.

The transmission channel is possibly followed by post-processing (for example decompression or deserialization) and again a register stage for synchronization in the case of possibly different time domains. This latency from the output channel block to this point is referred to as the channel transfer latency below. The channel signal conditioning latency, for example a converter latency, until the data are present at the I/O pin is additionally added to the total output latency of a channel. The reverse path applies to an input channel.

In the present disclosure, automatic jitter compensation of the channels in an I/O group can also be optionally carried out. Jitter is not produced by the signal conditioning, but rather by transmitting the data to the input/output circuit (I/O board), for example if a plurality of I/O channels of the circuit are supplied via a serial communication channel and the output delay is dependent on the load on the communication channel. This jitter can be compensated for by an intermediate register stage on the circuit (I/O board). The register values are then switched further, for example, only after waiting for the maximum jitter time. This presupposes that this jitter time can be determined or is known.

Latency differences of the individual channels on the I/O board can then still be directly compensated for on the board. For this purpose, a programmable delay circuit (for example an FPGA) can be used on the I/O board. An upstream or downstream circuit (for example FPGA circuit or processor circuit) then informs the circuit, for example during initialization, of which channels are intended to operate in a synchronous manner or with which latency offset. Alternatively, the upstream or downstream circuit directly programs the necessary delays into the circuit having the channels.

FIG. 7 illustrates an application in which both input channels and output channels of a circuit are combined in a group.

The present disclosure means that the time at which the signals are output at the channel outputs is the same as the time at which the input signals are sampled at the respective pin or has an adjustable offset.

If necessary, a group trigger for the input channels preferably must be automatically delayed until the output signals are present at the pin. In the case of mixed I/O groups, the mixed latency (cf. FIG. 7) can be indicated and output at a latency port of the input channel objects. In the case of mixed groups, the output latency is identical to the group latency of a pure output group.

In the case of mixed groups, the input latency is the sum of the group latencies of pure output and input groups.

1-12. (canceled)

13. A method for temporally synchronizing the output of signals and/or temporally synchronizing the processing of captured signals on a plurality of input and/or output channels of an electronic circuit, comprising the following steps of:
a. combining a portion of all channels of the electronic circuit to form a logical group,
b. retrieving a channel latency of each channel belonging to the logical group from a data source,
c. determining a greatest channel latency from all retrieved channel latencies and at least temporarily storing the greatest channel latency as a logical group latency,
d. for each channel belonging to the logical group: determining a temporal difference between the logical group latency and the retrieved channel latency and storing a determined difference as a channel-associated latency offset in a memory of the electronic circuit,
e. influencing a signal propagation via a respective channel on a basis of at least a respective stored latency offset.

14. The method of claim 13, wherein a channel is assigned to the logical group by storing a group identification, in particular a group number, in a channel object of a user interface, which channel object is assigned to the channel.

15. The method of claim 13, wherein the channel is assigned to the logical group by generating a group object and storing a channel object of the channel in the group object of a user interface.

16. The method of claim 13, wherein at least values for the channel latency and the logical group latency are depicted in the channel object.

17. The method of claim 13, wherein an activity signal is generated on the basis of a group latency, which activity signal indicates the time at which the channels in the group have an active signal at their channel connections or their associated memory, in particular wherein the signal is assigned to the channel object and/or group object.

18. The method of claim 13, wherein a channel offset is stored in the channel object for at least one of the channels in the group, which channel offset is used to define an intended deviation of the signal propagation via the channel from the group latency.

19. The method of claim 18, wherein the value of the group latency of a group is changed on the basis of at least one channel offset, in particular before step d) of claim 13 is carried out.

20. The method of claim 13, wherein at least steps a) to d) are carried out using a graphical user interface which is implemented by means of software on a data processing system which is connected to the circuit by at least one communication connection in a bidirectional manner.

21. The method of claim 13, wherein step e) is carried out by software or hardware-implemented logic of the circuit, to which the latency offsets of all channels in the group have been transmitted by means of previous communication.

22. The method of claim 13, wherein the data source for retrieving the channel latencies is formed by
a. a set of channel-assigned data which are stored on the data processing system on which the graphical user interface is executed, and are read into the software for generating the user interface, or
b. a set of channel-assigned data which are stored in a memory element common to all channels, on the circuit, from which the data are read and are transmitted, by means of communication, to the software for generating the user interface,
c. a set of data which are directly input into the software for generating the user interface by a user of said software,
d. a set of data which is loaded, via a communication network, from a server onto the data processing system on which the graphical user interface is executed, and which are read into the software for generating the user interface.

23. The method of claim 13, wherein
a. the function of that channel in the group which has the greatest retrieved channel latency is initially triggered at an initial triggering time for the purpose of initiating signal processing with this channel, and the function of the remaining channels in the group is gradually triggered for the purpose of initiating signal processing with the respective channel in the order of decreasing retrieved channel latencies with an interval of time between their respective stored latency offset, in particular plus a positive or negative channel offset, and the initial triggering time, or
b. the functions of all channels in the group are triggered at the same time for processing respective signals and the signals processed by the channel function are each buffered in a register, and the processed signal of each channel is supplied, from the register, to further processing in a manner delayed with the respective stored latency offset, in particular plus a positive or negative channel offset,
c. in the case of groups having input and output channels, the respective triggers for initiating signal output and signal input are effected at the same time or are effected in a manner offset by a predeterminable positive or negative time value, in particular by the maximum latency among the output channels.

24. The method of claim 13, wherein the times for the signal conditioning in the channel and the time for transferring the signal via the channel are added in order to form a value for a channel latency.
